(19) United States
(12) Patent Application Publication
(10) Pub. No.: US 2023/0262463 A1
(43) Pub. Date: Aug. 17, 2023

(54) MOBILE NETWORK AUTHENTICATION USING A CONCEALED IDENTITY

(71) Applicant: Lenovo (Singapore) Pte. Ltd., New Tech Park (SG)

(72) Inventors: Andreas Kunz, Ladenburg (DE); Apostolis Salkintzis, Athens (GR); Sheeba Backia Mary Baskaran, Friedrichsdorf (DE); Roozbeh Atarius, La Jolla, CA (US)

(21) Appl. No.: 18/012,360

(22) PCT Filed: Jun. 22, 2020
(86) PCT No.: PCT/EP2020/067372

§ 371 Date: Dec. 22, 2022

(51) Int. Cl. H04W 12/108; H04W 12/02; H04W 12/06; H04W 12/12; H04W 12/72

(52) U.S. Cl. CPC H04W 12/108; H04W 12/02; H04W 12/06; H04W 12/12; H04W 12/72

(57) ABSTRACT

Apparatuses, methods, and systems are disclosed for supporting authentication with a mobile core network using a concealed identity. One apparatus includes a processor that sends a first authentication message that includes a concealed identifier to a network function to authenticate with a mobile communication network via a non-3GPP access network. The processor receives a second authentication message from the network function in response to the first authentication message. The second authentication message comprises an authentication response based on the concealed identifier. The processor completes authentication with the mobile communication network in response to the authentication response comprising a challenge packet. The processor receives configuration information for accessing the mobile communication network in response to successful authentication with the mobile communication network.

The subject matter disclosed herein relates generally to supporting authentication with a mobile core network using a concealed identity.

### BACKGROUND

The following abbreviations and acronyms are herewith defined, at least some of which are referred to within the following description.

Third Generation Partnership Project (“3GPP”), Fifth-Generation Core network (“5GC”), Access and Mobility Management Function (“AMF”), Access Point Name (“APN”), Access Stratum (“AS”), Access Network Information (“ANI”), Application Programing Interface (“API”), Data Network Name (“DNN”), Downlink (“DL”), Enhanced Mobile Broadband (“eMBB”), Evolved Node-B (“eNB”), Evolved Packet Core (“EPC”), Evolved UMTS Terrestrial Radio Access Network (“E-UTRAN”), Home Subscriber Server (“HSS”), IP Multimedia Subsystem (“IMS,” aka “IP Multimedia Core Network Subsystem”), Internet Protocol (“IP”), Long Term Evolution (“LTE”), LTE Advanced (“LTE-A”), Medium Access Control (“MAC”), Mobile Network Operator (“MNO”), Mobility Management Entity (“MME”), Non-Access Stratum (“NAS”), Narrowband (“NB”), Network Function (“NF”), Network Access Identifier (“NAI”), Next Generation (e.g., 5G) Node-B (“gNB”), Next Generation Radio Access Network (“NG-RAN”), New Radio (“NR”), Non-3GPP Access Network (“N3AN”), Policy Control Function (“PCF”), Packet Data Network (“PDN”), Packet Data Unit (“PDU”), PDN Gateway (“PGW”), Public Land Mobile Network (“PLMN”), Quality of Service (“QoS”), Radio Access Network (“RAN”), Radio Access Technology (“RAT”), Radio Resource Control (“RRC”), Receive (“Rx”), Security Mode Control (“SMC”), Single Network Slice Selection Assistance Information (“S-NSSAI”), Serving Gateway (“SGW”), Session Management Function (“SMF”), Transmission Control Protocol (“TCP”), Transmit (“Tx”), Trusted Non-3GPP Access Network (“TNAN”), Trusted Non-3GPP Access Point (“TNAP”), Trusted Non-3GPP Gateway Function (“TNGF”), Unified Data Management (“UDM”), User Entity/Equipment (Mobile Terminal) (“UE”), Uplink (“UL”), User Plane (“UP”), Universal Mobile Telecommunications System (“UMTS”), User Datagram Protocol (“UDP”), User Location Information (“ULI”), Wireless Local Area Network (“WLAN”), and Worldwide Interoperability for Microwave Access (“WiMAX”).

In certain embodiments, a UE may access a 5G core (“5GC”) network via a gateway function in a non-3GPP access network (“N3AN”).

### BRIEF SUMMARY

One method of a UE, e.g., for supporting authentication with a mobile core network using a concealed identity, includes sending a first authentication message to a network function to authenticate with the mobile communication network via the non-3GPP access network. Here, the first authentication message includes a concealed identifier for the apparatus. The method includes receiving a second authentication message from the network function in response to the first authentication message. Here, the second authentication message includes an authentication response based on the concealed identifier. The method includes completing authentication with the mobile communication network in response to the authentication response comprising a challenge packet. The method includes receiving configuration information for accessing the mobile communication network in response to successful authentication with the mobile communication network.

One method of a AAA function, e.g., for supporting authentication with a mobile core network using a concealed identity, includes receiving a first authentication message from a network function to authenticate a remote unit with the mobile communication network via a non-3GPP access network. Here, the first authentication message includes an identifier for the remote unit and an authentication type. The method includes detecting that the identifier is a concealed identifier for the remote unit. Here, the concealed identifier indicates that the remote unit is 5G capable. The method includes creating an authentication vector request message comprising the concealed identifier and an authentication method, the authentication type specifying the authentication method. The method includes sending the authentication vector request message to the network function. Here, the network function de-conceals the concealed identifier to retrieve a permanent identifier for the remote unit. The method includes receiving an authentication vector response message from the network function. Here, the authentication vector response message includes an authentication vector and the permanent identifier for the remote unit.

One method of an HSS, e.g., for supporting authentication with a mobile core network using a concealed identity, includes receiving an authentication vector request message from a first network function to authenticate a remote unit with the mobile communication network via a non-3GPP access network. Here, the authentication vector request message includes an identifier for the remote unit. The method includes detecting that the identifier is a concealed identifier for the remote unit. Here, the concealed identifier indicates that the remote unit is 5G capable. The method includes selecting a second network function based on the concealed identifier. Here, the second network function configured to de-conceal the concealed identifier. The method includes sending the authentication vector request message to the second network function for requesting an authentication vector associated with the concealed identifier and the authentication type. The method includes receiving an authentication vector response message from the second network function. Here, the authentication vector response message includes the authentication vector and a permanent identifier for the remote unit.

One method of a UDM, e.g., for supporting authentication with a mobile core network using a concealed identity, includes receiving an authentication vector request message from a network function to authenticate a remote unit with the mobile communication network via a non-3GPP access network. Here, the authentication vector request message includes an identifier for the remote unit and an authentication type. The method includes detecting that the identifier is a concealed identifier for the remote unit. Here, the concealed identifier indicates that the remote unit is 5G capable. The method includes de-concealing the concealed identifier to determine a permanent identifier for the remote unit. The method includes creating an authentication vector response message comprising the de-concealed permanent identifier for the remote unit and an authentication method, the authentication type specifying the authentication method. The method includes sending the authentication vector response message to the network function.

One method of an AUSF, e.g., for supporting authentication with a mobile core network using a concealed identity, includes receiving an authentication vector request message from a network function to authenticate a remote unit with the mobile communication network via a non-3GPP access network. Here, the authentication vector request message includes an identifier for the remote unit. The method includes detecting that the identifier is a concealed identifier for the remote unit. Here, the concealed identifier indicating that the remote unit is 5G capable. The method includes selecting a network function for de-concealing the concealed identifier based on a routing identifier of the concealed identifier. The method includes sending an authentication vector request message to the network function. Here, the network function de-conceals the concealed identifier to retrieve a permanent identifier for the remote unit. The method includes receiving an authentication vector response message from the network function. Here, the authentication vector response message includes an authentication vector and the permanent identifier for the remote unit.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a diagram illustrating one embodiment of a wireless communication system for supporting authentication with a mobile core network using a concealed identity;

FIG. 2A is a signal flow diagram illustrating one embodiment of solution for supporting authentication with a mobile core network using a concealed identity;

FIG. 2B is a continuation of the procedure depicted in FIG. 2A;

FIG. 2C is a continuation of the procedure depicted in FIG. 2A;

FIG. 2D is a is a continuation of the procedure depicted in FIGS. 2B and 2C;

FIG. 3 is a block diagram illustrating one embodiment of a user equipment apparatus that supports authentication with a mobile core network using a concealed identity;

FIG. 4 is a block diagram illustrating one embodiment of a network equipment apparatus that supports authentication with a mobile core network using a concealed identity;

FIG. 5 is a flow chart diagram illustrating one embodiment of a first method for supporting authentication with a mobile core network using a concealed identity;

FIG. 6 is a flow chart diagram illustrating one embodiment of a second method for supporting authentication with a mobile core network using a concealed identity;

FIG. 7 is a flow chart diagram illustrating one embodiment of a third method for supporting authentication with a mobile core network using a concealed identity;

FIG. 8 is a flow chart diagram illustrating one embodiment of a fourth method for supporting authentication with a mobile core network using a concealed identity; and

FIG. 9 is a flow chart diagram illustrating one embodiment of a fifth method for supporting authentication with a mobile core network using a concealed identity.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures, including alternate embodiments of like elements.

Methods, apparatuses, and systems are disclosed for supporting authentication with a mobile core network using a concealed identity. Currently, the procedure in 3GPP TS 33.402 for trusted non-3GPP access foresees that a UE sends its international mobile subscriber identity (“IMSI”) in clear text, e.g., an unencrypted, over the air interface and to a AAA server in a core network. A 5G UE may be backwards compatible to earlier generations, but the security measures implemented in earlier technologies may not have the same level of security as in 5G, e.g., lower level of security as in 5G, less security requirements as in 5G, or the like.

The resulting problem is a bidding down attack of a 5G capable UE to retrieve the secret subscriber identity when redirecting the UE to a non-3GPP access to EPC because the UE may behave like a 4G UE and may send its secret subscriber identity directly in the first message or as an answer to the identity request message, as described currently in 3GPP TS 33.402 v15.0.0. This 4G behavior of a 5G UE may be a violation of the 5G requirement where the secret subscriber permanent identity (“SUPI”) may need to be concealed in the first message or as an answer to the identity request message.

As described in currently in TS 33.402, for authentication, the UE sends an EAP Response/Identity message. The UE shall send its identity complying with Network Access Identifier (“NAI”) format currently specified in 3GPP TS 23.003 v16.0.0 (i.e., having the format ‘username@realm’). NAI contains either a pseudonym allocated to the UE in a previous run of the authentication procedure or, in the case of first authentication, the IMSI. In the case of first authentication, the NAI shall indicate EAP-AKA′ as specified in TS 23.003.

The UE may send the secret subscriber identity, which may have been derived from its IMSI or may be the same as its IMSI, before any secure channel for the encryption is enabled. Because the UE is 5G capable, it may not do the same during 5G procedures, as in 5G the subscriber identity privacy may be required to be supported by the UE and the network as well during the non-3GPP access procedures to 5GC.

Disclosed herein are procedures that enable a 5G capable UE to perform “access authentication for non-3GPP access in EPS,” as currently specified in TS 33.402, clause 6.2. As used herein, “access authentication for non-3GPP access network in EPS” refers to authentication for the access (i.e., non-3GPP access network) and receiving an IP address. After that the UE is able to register to the 5GC network by means of NAS signaling, where the UE will be authenticated by the 5GC. In other words, the UE may access the 5GC and it may also connect to a non-3GPP access network by using EAP-AKA/EAP-AKA′ authentication with the EPC. The UE may be a 4G and 5G dual mode UE, which may use a SUCI as required by 5G for any registration, e.g., non-3GPP registration, where SUCI is a concealed secret subscriber identity that may have been derived from the UE's IMSI or may be the same as the UE's IMSI.

Because the UE is 5G capable, its secret subscriber identity—subscription permanent identity (“SUPI”)—may be concealed, e.g., SUCI or replaced with a temporary identity such as a 5G-GUTI. The subject matter disclosed herein describes applying the same concept to 4G non-3GPP access for 5G capable UEs, e.g., the UE uses its concealed 5G identity in the EAP response towards the 4G network. Enhancements in the network may be necessary in order to support such a big change such as, for example, the UE does not need to support NAS protocol over non-3GPP access for the following embodiment, e.g., the UE has 3GPP credentials but may not support NAS over non-3GPP access.

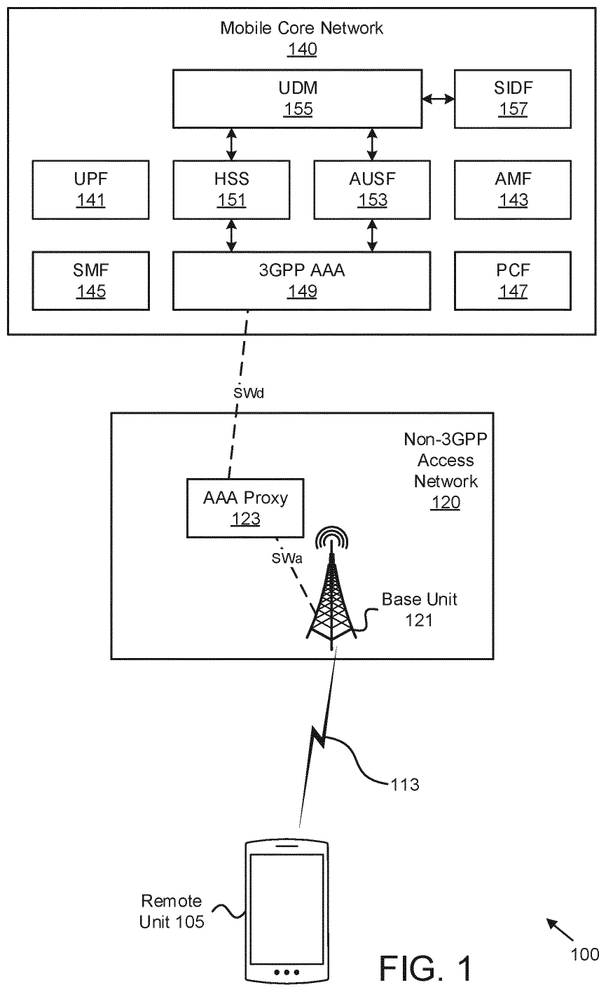

FIG. 1 depicts a wireless communication system 100 for supporting authentication with a mobile core network using a concealed identity. In one embodiment, the wireless communication system 100 includes at least one remote unit 105, at least one non-3GPP access network 120, which may include a trusted non-3GPP access network (“TNAN”), and a mobile core network 140 in a PLMN. One of skill in the art, however, will recognize in light of this disclosure that an untrusted non-3GPP access network may also be used. The non-3GPP access network 120 may be composed of at least one base unit 121. The remote unit 105 may communicate with the non-3GPP access network 120 using non-3GPP communication links 113, according to a radio access technology deployed by non-3GPP access network 120. Even though a specific number of remote units 105, base units 121, non-3GPP access networks 120, and mobile core networks 140 are depicted in FIG. 1, one of skill in the art will recognize that any number of remote units 105, base units 121, non-3GPP access networks 120, and mobile core networks 140 may be included in the wireless communication system 100.

In one implementation, the wireless communication system 100 is compliant with the 4G and 5G system specified in the 3GPP specifications. More generally, however, the wireless communication system 100 may implement some other open or proprietary communication network, for example, LTE/EPC (referred as ‘4G’) or WiMAX, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the base units 121 in the non-3GPP access network 120 via uplink (“UL”) and downlink (“DL”) communication signals. Furthermore, the UL and DL communication signals may be carried over the communication links 113. Note, that the non-3GPP access network 120 is an intermediate network that provide the remote units 105 with access to the mobile core network 140.

The base units 121 may serve a number of remote units 105 within a serving area, for example, a cell or a cell sector, via a communication link 113. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the communication links 113. The communication links 113 may be any suitable carrier in licensed or unlicensed radio spectrum. The communication links 113 facilitate communication between one or more of the remote units 105 and/or one or more of the base units 121.

As noted above, the non-3GPP access network 120 supports secure signaling interfaces and interworking with the 4G and 5G core network. The non-3GPP access network 120 may include a Proxy AAA; in the depicted embodiment, the non-3GPP access network 120 includes a AAA proxy 123.

The base units 121 may be distributed over a geographic region. In certain embodiments, a base unit 121 may also be referred to as a Non-3GPP Access Point, an access terminal, an access point, a base, a base station, a relay node, a device, or by any other terminology used in the art. The base units 121 are generally part of a radio access network (“RAN”), such as the non-3GPP access network 120, that may include one or more controllers communicably coupled to one or more corresponding base units 121. These and other elements of radio access network are not illustrated but are well known generally by those having ordinary skill in the art. The base units 121 connect to the mobile core network 140 via the non-3GPP access network 120.

In some embodiments, the remote units 105 communicate with an application server (or other communication peer) via a network connection with the mobile core network 140. For example, an application in a remote unit 105 (e.g., web browser, media client, telephone/VoIP application) may trigger the remote unit 105 to establish a PDU session (or other data connection) with the mobile core network 140 using the non-3GPP access network 120. In order to establish the PDU session, the remote unit 105 must be registered with the mobile core network.

In one embodiment, the mobile core network 140 is a 5G core (“5GC”) or the evolved packet core (“EPC”), which may be coupled to a data network (such as the Internet and private data networks, among other data networks). A remote unit 105 may have a subscription or other account with the mobile core network 140. The present disclosure is not intended to be limited to the implementation of any particular wireless communication system architecture or protocol.

The mobile core network 140 includes several network functions (“NFs”). As depicted, the mobile core network 140 includes at least one user plane function (“UPF”) 141. The mobile core network 140 also includes multiple control plane functions including, but not limited to, an Access and Mobility Management Function (“AMF”) 143, a Session Management Function (“SMF”) 145, and a Policy Control Function (“PCF”) 147. In certain embodiments, the mobile core network 140 may also include a Home Subscriber Server (“HSS”) 151, a Unified Data Management function (“UDM”) 155, an Authentication Server Function (“AUSF”) 153, a Subscription Identifier De-concealing Function (“SIDF”) 157, a Network Repository Function (“NRF”) (used by the various NFs to discover and communicate with each other over APIs), or other NFs defined for the 5G Core. In certain embodiments, the mobile core network 140 may also include a 3GPP AAA server 149 to provide authentication, authorization, policy control and routing information to access gateways or interworking functions for non-3GPP access. Note that the 3GPP AAA server may be consolidated and/or co-located with other network functions in the mobile core network 140.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. Each network slice includes a set of CP and UP network functions, wherein each network slice is optimized for a specific type of service or traffic class. The different network slices are not shown in FIG. 1 for ease of illustration, but their support is assumed. In one example, each network slice includes an SMF and a UPF, but the various network slices share the AMF 143, the PCF 147, and the UDM 155. In another example, each network slice includes an AMF, an SMF and a UPF.

Although specific numbers and types of network functions are depicted in FIG. 1, one of skill in the art will recognize that any number and type of network functions may be included in the mobile core network 140. While FIG. 1 depicts components of a 5G RAN and a 5G core network, the described embodiments for supporting authentication with a mobile core network using a concealed identity apply to other types of communication networks and RATs, including IEEE 802.11 variants, GSM, GPRS, UMTS, LTE variants, CDMA 2000, Bluetooth, ZigBee, Sigfoxx, and the like.

Moreover, where the mobile core network 140 comprises an EPC, the depicted network functions may be replaced with appropriate EPC entities, such as an MME, S-GW, P-GW, HSS, and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM may be mapped to an HSS, etc.

In various embodiments, the remote unit 105 is a 4G and 5G capable device that uses a concealed identifier, instead of an identifier that is sent in the clear, to register with a mobile core network 140, e.g., a 4G core network, a 5G core network, or the like, via a non-3GPP access network 120, e.g., a WLAN. The subject matter disclosed herein is directed to authenticating to a mobile core network using the concealed identifier for the remote unit 105 via access to a 3GPP AAA Server 149, an HSS 151, an AUSF 153, and a UDM 155 in a core mobile network 140 such as a 4G/5G core network to retrieve the permanent identifier for the remote device 105 that corresponds to the concealed identifier.

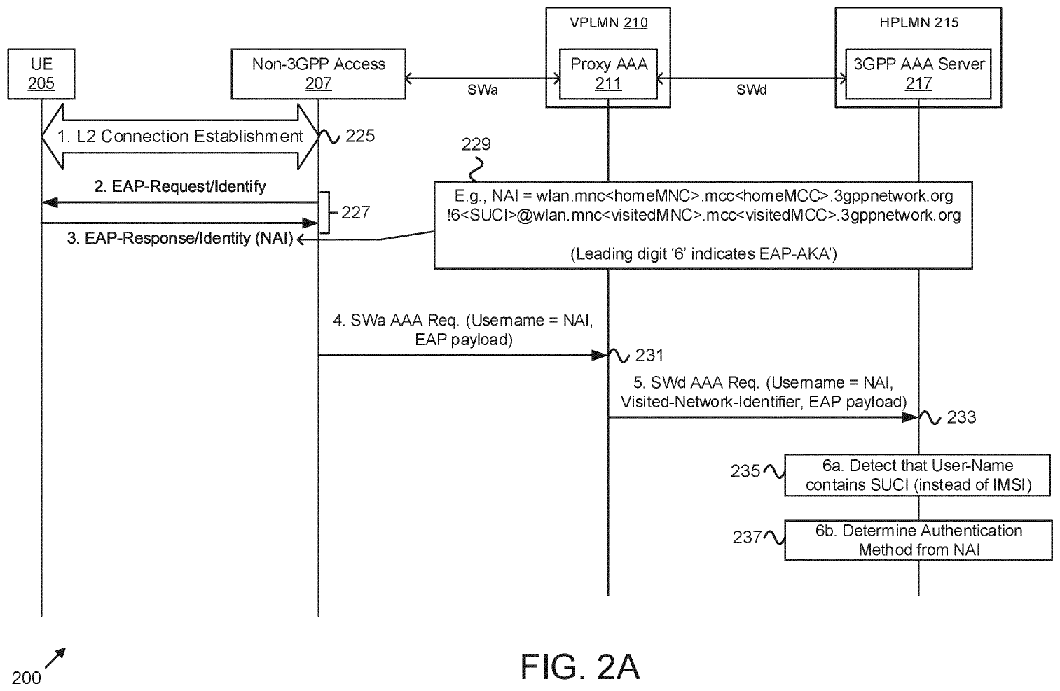

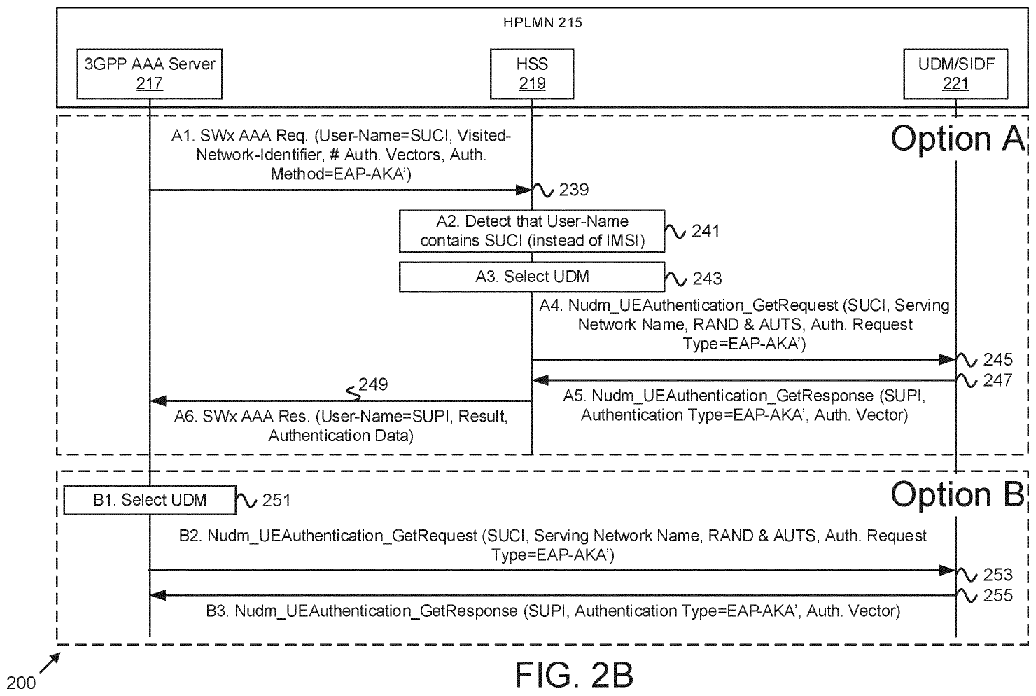

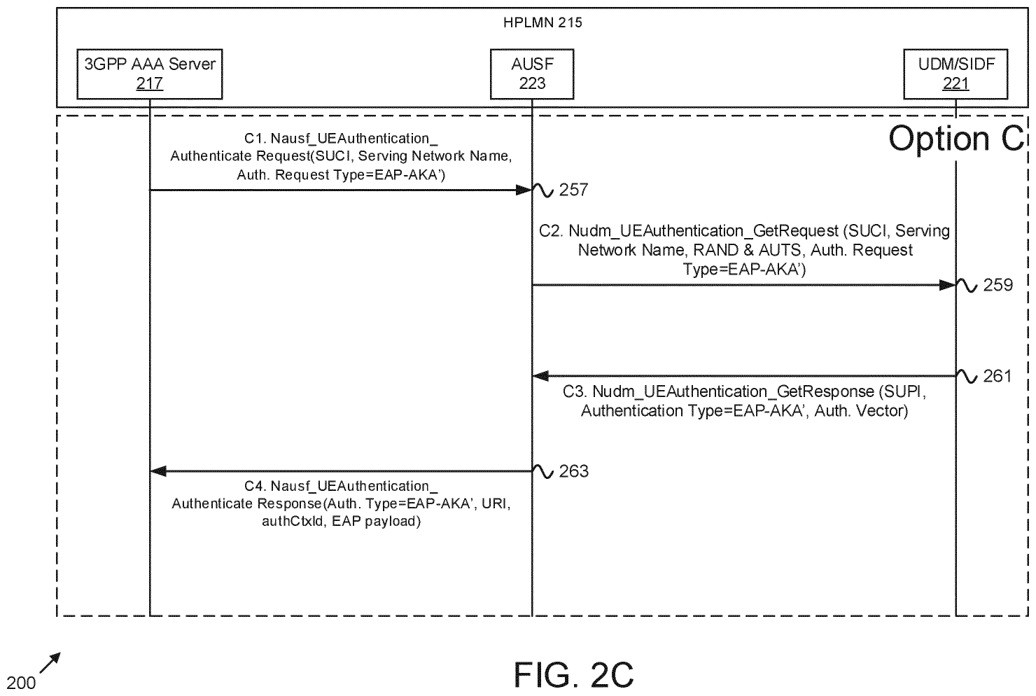

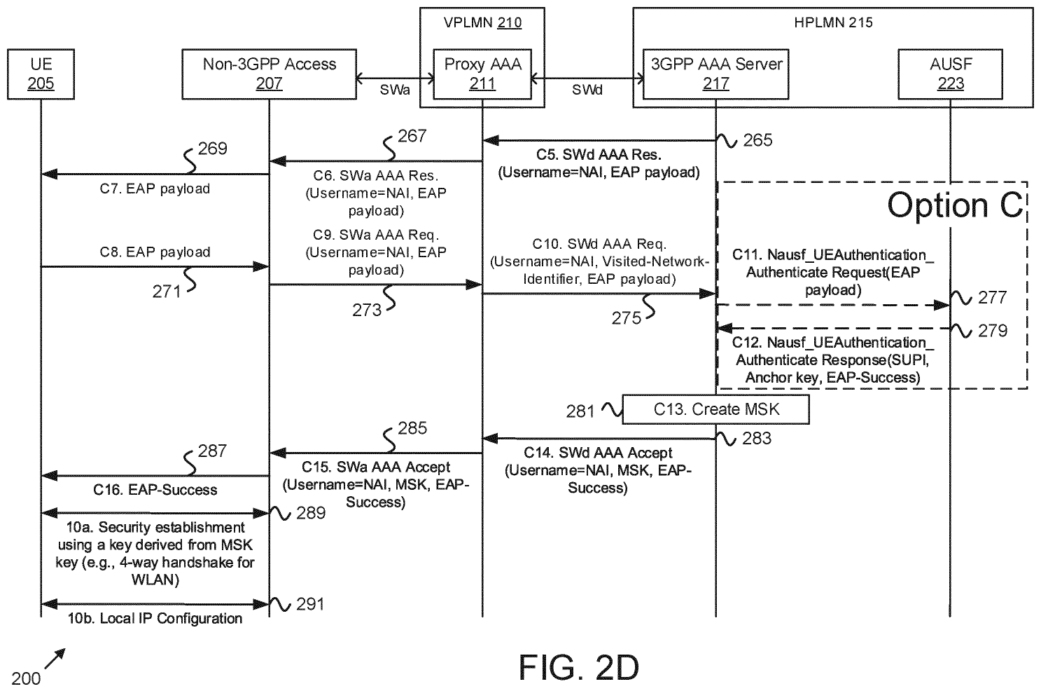

FIGS. 2A-2D depict a procedure 200 for supporting authentication with a mobile core network using a concealed identity, according to embodiments of the disclosure. The procedure 200 involves the UE 205 (e.g., one embodiment of the remote unit 105), a non-3GPP access network 207, and a proxy AAA server 211 (e.g., one embodiment of the AAA proxy 123) within a VPLMN 210. The procedure 200 also involves a 3GPP AAA server 217, an HSS 219 (in some implementations), an AUSF 223 (in other implementations), and a UDM/SIDF 221, which are within an HPLMN 215. In the most typical case, the trusted non-3GPP access network 210 is a WLAN access network complying with the IEEE 802.11 specification.

In one implementation, illustrated in FIGS. 2A, 2B, and 2D, the UE 205 provides the SUCI to the 3GPP AAA server 217 to not reveal its permanent subscription ID, e.g., the IMSI/SUPI. There are two options described below and shown in FIG. 2B: in Option A, the 3GPP AAA Server 217 accesses the SUPI from the UDM 221 via the HSS 219, and in Option B, the 3GPP AAA Server 217 accesses the SUPI from the UDM 221 directly from the UDM 221. In both options A and B, however, the 3GPP AAA Server 217 is performing the authentication.

In another implementation, illustrated as Option C in FIGS. 2A, 2C, and 2D, the 3GPP AAA Server 217 communicates with the AUSF 223 (e.g., instead of the HSS 219) and the authentication procedure runs between the UE 205 and the AUSF 223 (e.g., not between the UE 205 and the 3GPP AAA Server 217). In this embodiment, as explained in more detail below, the 3GPP AAA Server 217 detects that a SUCI is included in the NAI from the UE 205 instead of an IMSI. The 3GPP AAA Server 217 maps the authentication method indication from the NAI (e.g., 0, 1, 6, etc.) to indicate the authentication method to the AUSF 223, e.g. Authentication Method=EAP−AKA′. The interface between the 3GPP AAA Server 217 and the AUSF 223 may be a Service Based Interface (“SBI”) or a AAA interface and the 3GPP AAA Server 217 takes therefore either the role of an AMF (i.e., using SBI) or AAA Proxy 211 (i.e., using AAA interface). The AUSF 223 further provides this indication to the UDM 221 so that the indicated authentication method is chosen by the UDM 221 and not another one based on other local criteria in the UDM 221. The AUSF 223 authenticates the UE 205 and not the 3GPP AAA Server 217.

The procedure 200 begins at FIG. 2A, in Step 1 the UE 205 establishes a Layer-2 (L2) connection with a Non-3GPP Access Point, for example a WLAN access point, in the non-3GPP access network 207 (see messaging 225). In the case of an IEEE 802.11 WLAN, this L2 connection corresponds to an 802.11 Association. The WLAN AP may broadcast a PLMN list that includes the PLMN's with which the non-3GPP access 207 supports AAA connectivity. The UE 205 is 5G capable, but the non-3GPP access 207 advertises only AAA connectivity (interworking with EPC) for the PLMN the UE 205 is subscribed to. The UE 205 may connect to the WLAN AP.

At Steps 2-3, an EAP procedure is initiated by the non-3GPP access 207, e.g., a Non-3GPP Access Point or WLAN AP. EAP messages are encapsulated into Layer-2 packets, e.g., into IEEE 802.11/802.1x packets. The non-3GPP access 207 requests the UE Identity and the UE 205 sends a Network Access Identifier (“NAI”) as a response (see messaging 227). The UE 205 identifies the network as a network with AAA connectivity and sends in the EAP-Response its SUCI instead of the IMSI in the NAI format as defined in 3GPP TS 23.003 (see block 229), for example:

NAI=0<SUCI>@wlan.mnc<MNC>.MCC<MCC>.3gppnetwork.org Equation 1

NAI =0<SUCI>@nai.epc.MNC<MNC>.MCC<MCC>.3gppnetwork.org Equation 2

NAI=6<SUCI>@nai.epc.MNC<MNC>.MCC<MCC>.3gppnetwork.org Equation 3

NAI=wlan.mnc<homeMNC>.mcc<homeMCC>.3gppnetwork.org

!6<SUCI>@wlan.mnc<visitedMNC>.MCC<visitedMCC>.3gppnetwork.org Equation 4

where the leading digit identifies the authentication method, e.g., a leading 0 digit indicates EAP-AKA authentication and a leading 6 digit indicates EAP-AKA′ authentication.

As described herein, the UE 205 uses a concealed identifier, SUCI, as part of the NAI when connecting to the non-3GPP access network 207 using EAP-AKA, EAP-AKA′ authentication with the EPC, which may be required by 5G standards. The concealed identifier, SUCI, may be the UE's IMSI or may be derived from the UE's IMSI. Regardless, as described herein, the UE's identifier is concealed, e.g., encrypted, so that it is not sent in clear text in the air when connected to a 4G non-3GPP access network 207 using a 5G capable UE.

In step 4, the non-3GPP access 207 may forward the EAP-Response to the AAA proxy 211 (see messaging 231) in the VPLMN 210 based on the realm or domain of the NAI. The message that is forwarded to the AAA proxy 211 may include the NAI as the username and the EAP payload, e.g., SWa AAA Request (Username=NAI, EAP payload).

In step 5, the AAA proxy 211 in the VPLMN 210 sends the EAP-Response to the 3GPP AAA server 217 (see messaging 233) in the HPLMN 215 based on the realm/domain of the NAI. The message that is forwarded to the AAA proxy 211 may include the NAI as the username, an identifier for the VPLMN, and the EAP payload, e.g., SWd AAA Request (Username=NAI, Visited-Network-Identifier, EAP payload).

In step 6A (see block 235), the 3GPP AAA server 217 detects that the identifier in the username part of the NAI is a concealed identifier, e.g., the SUCI, instead of an IMSI. In step 6B (see block 237), the 3GPP AAA server 217 detects/determines the authentication method from the NAI, e.g., based on the SUCI prefix in the NAI (the leading 0, 1, 6, digits, for example).

At this point, the procedure 200 follows either Option A, Option B, or Option C depending on the implementation of the HPLMN 215. As depicted in FIG. 2B, in Option A, at step A1, the 3GPP AAA-Server 217 sends an authentication vector request (see messaging 239) with the concealed identifier, e.g., SUCI, as the username to the HSS 219 in the HPLMN 215 and an indication for the requested authentication method, e.g., Authentication Method=EAP-AKA′, which is derived from the SUCI prefix in the NAI. The authentication vector request that is sent to the HSS 219, for example, may have the form SWx AAA Request (User-Name=SUCI, Visited-Network-Identifier, # Auth. Vectors, Auth. Method=EAP-AKA′).

At step A2 (see block 241), the HSS 219 detects that the username is a concealed identifier, e.g., SUCI and not an IMSI. At step A3 (see block 243), the HSS 219 selects a UDM 221, e.g., based on routing identifier such as a home network ID (e.g., MCC, MNC) of the SUCI.

At step A4, the HSS 219 connects to the UDM 221 to request the authentication vector by sending an AKA-AV Request (see message 245) with the SUCI, and an indication for the requested authentication method to the UDM/SIDF 221. For example, the AKA-AV request may be Nudm_UEAuthentication_GetRequest (SUCI, Serving Network Name, RAND & AUTS, Auth. Request Type=EAP-AKA′). In an alternative embodiment of Step A4, the HSS 219 connects to the UDM 221 for requesting de-concealing of the concealed identifier, e.g., SUCI, by sending an Identity Request with the SUCI to the UDM/SIDF 221.

At step A5, the UDM 221 verifies the AKA-AV request and queries the SIDF 221 for de-concealing the concealed identifier, e.g., SUCI, to reveal the permanent identifier, e.g., SUPI. The UDM 221 generates the AKA-AV response according to the requested authentication method e.g., as for 5G EAP-AKA′ primary authentication. The UDM 221 may generate an EAP-AKA AV instead of an EAP-AKA′ AV. The UDM 221 provides (see messaging 247) the AKA-AV for EAP-AKA or EAP-AKA′ in an AKA AV Response to the request that is received in step A4 to the HSS 219. For example, the EAP-AKA AV response may be Nudm_UEAuthentication_GetResponse (SUPI, Authentication Type=EAP-AKA′, Auth. Vector).

In an alternative embodiment of step A5, where an Identity Request was sent to the UDM 221 in step A4, the UDM 221 verifies the request and queries the SIDF 221 for de-concealing the concealed identifier, e.g., SUCI, to reveal the permanent identifier, e.g., SUPI, and sends the SUPI in an Identity Response to the request that is received in the alternative step A4 to the HSS 219. The UDM 221 sends the permanent identifier, e.g., SUPI, in IMSI format to the HSS 219.

In step A6, the HSS 219 selects the corresponding subscriber profile based on the received permanent identifier, e.g., SUPI, and generates and provides the AKA-AV to the 3GPP AAA Server 217 (see messaging 249). The AKA-AV that the HSS sends to the 3GPP AAA Server 217 may be SWx AAA Response (User-Name=SUPI, Result, Authentication Data). In this case, only the HSS 219 needs to be enhanced to communicate with the UDM 221 for de-concealing the concealed identifier, e.g., SUCI. The HSS 219 may generate an EAP-AKA′ AV instead of an EAP-AKA AV based on the indication for the requested authentication method.

Continuing with FIG. 2B, in Option B at step B1, the 3GPP AAA Server 217 selects a UDM 221 (see block 251) directly instead of using the HSS 219. The UDM 221 may be selected based on the routing identifier of the concealed identifier, e.g., the SUCI.

At step B2, the 3GPP AAA Server 217 sends the AKA-AV request (see messaging 253) directly to the UDM 221, when using an AAA interface. In some implementations, if the 3GPP AAA Server 217 is enhanced with a Service Based Interface (“SBI”), then it behaves like an AUSF 223 and sends a Nudm_UEAuthentication_Get Request to the UDM 221, e.g., Nudm_UEAuthentication_GetRequest(SUCI, Serving Network Name, RAND & AUTS, Auth. Request Type=EAP-AKA′). Accordingly, the request to the UDM 221 includes the concealed identifier, e.g., SUCI, and an indication for the requested authentication method, e.g. Authentication Request Type=EAP-AKA′.

At step B3, the UDM 221 de-conceals the concealed identifier, e.g., SUCI, to reveal the permanent identifier, e.g., SUPI to select the subscriber profile and to generate the EAP-AKA′ authentication vector similar to 5G EAP-AKA′ primary authentication. The UDM 221 provides (see messaging 255) the AKA-AV, including the permanent identifier, e.g., SUPI, back to the 3GPP AAA Server 217, e.g., Nudm_UEAuthentication_GetResponse(SUPI, Authentication Type=EAP-AKA′, Auth. Vector). The UDM 221 may generate an EAP-AKA AV instead of an EAP-AKA′ AV according to the requested authentication method from the 3GPP AAA Server 217.

Referring now to FIG. 2C, in Option C at step C1, the 3GPP AAA Server 217 sends (see messaging 257) an authentication vector request with the concealed identifier as the username, e.g., username=SUCI, to the AUSF 223 and an indication for the requested authentication method, e.g. Authentication Request Type=EAP-AKA′. The message depends on the interface between 3GPP AAA Server 217 and the AUSF 223—if the 3GPP AAA Server 217 hosts a SBI with the AUSF 223, then the 3GPP AAA Server 217 sends a Nausf_UEAuthentication_Authenticate Request message with the concealed identifier, e.g., Nausf_UEAuthentication_Authenticate Request(SUCI, Serving Network Name, Auth. Request Type=EAP-AKA′). Alternatively, if the 3GPP AAA Server 217 hosts a AAA protocol interface with the AUSF 223, then the 3GPP AAA Server 217 sends an AKA AV request to the AUSF 223.

At step C2, the AUSF 223 selects a UDM 221, e.g. based on the routing identifier of the SUCI, and sends (see messaging 259) a UE Authentication Request with the concealed identifier, e.g., SUCI, and an indication for the requested authentication method to the UDM/SIDF 221. For example, the AUSF 223 may send a Nudm_UEAuthentication_GetRequest message, e.g., Nudm_UEAuthentication_GetRequest(SUCI, Serving Network Name, RAND & AUTS, Auth. Request Type=EAP-AKA′).

At step C3, the UDM 221 verifies the received UE Authentication Request and queries the SIDF 221 for de-concealing the concealed identifier, e.g., SUCI, to reveal the permanent identifier, e.g., SUPI. The UDM 221 generates the AKA-AV according to the requested authentication method e.g., as for 5G EAP-AKA′ primary authentication. The UDM 221 may generate an EAP-AKA AV instead of an EAP-AKA′ AV according to the requested authentication method. The UDM 221 provides (see messaging 261) the authentication vector in a UE Authentication Response to the AUSF 223. For example, the UDM 221 may send a Nudm_UEAuthentication_GetResponse message, e.g., Nudm_UEAuthentication_GetResponse (SUPI, Authentication Type=EAP-AKA′, Auth. Vector).

At step C4, the AUSF 223 begins authentication towards the UE 205 by sending an authentication response message (see messaging 263) to the 3GPP AAA Server 217. For example, the AUSF 223 may send a Nausf_UEAuthentication_Authenticate Response message such as Nausf_UEAuthentication_Authenticate Response(Auth. Type=EAP-AKA′, URI, authCtxld, EAP payload).

Depending on how the 3GPP AAA Server 217 is connected to the AUSF 223, it may take several roles. For instance, if the 3GPP AAA Server 217 hosts an SBI with the AUSF 223, then the 3GPP AAA Server 217 takes the role as an AMF. In another implementation, if the 3GPP AAA Server 217 hosts a AAA protocol interface with the AUSF 223, then the 3GPP AAA Server takes the role as a AAA Proxy 211.

Referring now to FIG. 2D, which is applicable to each of Option A, Option B, and Option C, unless otherwise specified, the procedure 200 in steps C5-C16 (see messaging 265-287) generally follows the normal authentication procedure specified in 3GPP TS 33.402 v16.2.0 subclause 6.2 to authenticate the UE 205 and to complete the EAP authentication procedure. In some implementations, the 3GPP AAA Server 217 may take the role of the AUSF 223 for authenticating the 5G capable UE 205.

In step C5, the 3GPP AAA Server 217 sends (see messaging 265) a response with the username, e.g., NAI, and the EAP payload to the Proxy AAA 211 in the VPLMN 210. For example, the EAP response message may be SWd AAA Response(Username=NAI, EAP payload).

In step C6, the Proxy AAA 211 sends (see messaging 267) a response with the username and payload that is received from the 3GPP AAA Server 217, e.g., SWa AAA Response (Username=NAI, EAP payload) to the Non-3GPP Access 207.

In step C7, the non-3GPP Access 207 sends (see messaging 269) the EAP payload, e.g., an EAP-Request/AKA-Challenge, to the UE 205. When the UE 205 receives the EAP-Request/AKA-Challenge, it knows that it performs only access authentication according to 3GPP TS 33.402, subclause 6.2 and not a full primary authentication to the SGC. In particular, if the network responds with an EAP-AKA challenge, this indicates that the network supports de-concealment of the concealed identifier, e.g., SUCI using the 3GPP AAA Server 217, HSS 219, and/or AUSF 223 connected to the UDM 221, as described in the procedure flow above in FIGS. 2A-2C. Otherwise, if the network responds with an authentication rejection, then the network's 4G 3GPP AAA Server 217, HSS 219, and/or AUSF 223 did not understand the SUCI.

In steps C8-C10, the procedure 200 sends (see messaging 271-275) further EAP authentication messages to the 3GPP AAA Server 217 to proceed with EAP authentication in response to receiving the challenge packet in step C7. In Option C, at steps C11 and C12, the procedure 200 exchanges (see messaging 277-279) additional authentication messages with the AUSF 223 to proceed with authentication. In steps C13-C16, the 3GPP AAA Server 217 creates an MSK (see block 281) and sends (see messaging 283-287) an EAP-Success flag to the UE 205.

In Steps 10A-10B, after successful authentication, e.g., after receiving an EAP-Success flag, the 5G UE 205 receives IP configuration access information. Security establishment with the Non-3GPP Access 207 may be established (see messaging 289) using a key derived from the MSK, e.g., as part of a 4-way handshake for a WLAN. In certain embodiments, the UE 205 may only have local IP access (see messaging 291) at the Non-3GPP Access 207 and may not have access to the SGC.

While FIGS. 2A-2D depict the UE 205 interacting with the 3GPP AAA server 217 in the HPLMN 215 via the Proxy AAA 211 in the VPLMN 210, in other embodiments, the UE 205 may interact with the 3GPP AAA serer 217 via the non-3GPP access 207 without the use of the proxy AAA 211. For example, if the UE 205 is not roaming, then the UE 205 may interact with the 3GPP AAA serer 217 via the non-3GPP access 207 without the use of the proxy AAA 211.

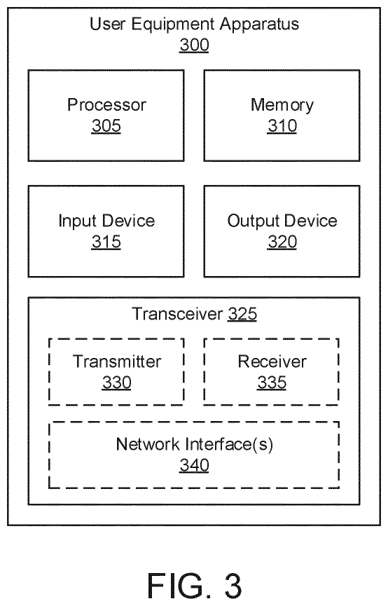

FIG. 3 depicts one embodiment of a user equipment apparatus 300, according to embodiments of the disclosure. The user equipment apparatus 300 may be one embodiment of the remote unit 105 and/or the UE 205. Furthermore, the user equipment apparatus 300 may include a processor 305, a memory 310, an input device 315, an output device 320, a transceiver 325. In some embodiments, the input device 315 and the output device 320 are combined into a single device, such as a touch screen. In certain embodiments, the user equipment apparatus 300 does not include any input device 315 and/or output device 320.

As depicted, the transceiver 325 includes at least one transmitter 330 and at least one receiver 335. Here, the transceiver 325 communicates with a mobile core network (e.g., a 7GC) via an access network. Additionally, the transceiver 325 may support at least one network interface 340. Here, the at least one network interface 340 facilitates communication with an AAA Proxy 123 or AAA Server 149.

The processor 305, in one embodiment, may include any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 305 executes instructions stored in the memory 310 to perform the methods and routines described herein. The processor 305 is communicatively coupled to the memory 310, the input device 315, the output device 320, and the transceiver 325.

In various embodiments, the processor 305 controls the user equipment apparatus 300 to implement the above described UE behaviors. In some embodiments, the processor 305 sends a first authentication message (e.g., via the transceiver 325) to a network function to authenticate with the mobile communication network via the non-3GPP access network. The first authentication message includes a concealed identifier for the apparatus 300. In certain embodiments, the processor 305 receives (e.g., via the transceiver 325) a second authentication message from the network function in response to the first authentication message. Here, the second authentication message includes an authentication response based on the concealed identifier.

In further embodiments, the processor 305 completes authentication with the mobile communication network in response to the authentication response comprising a challenge packet and receives configuration information for accessing the mobile communication network in response to successful authentication with the mobile communication network.

In one embodiment, the concealed identifier for the apparatus 300 that is sent in the first authentication message to the network function comprises a subscription concealed identifier. In certain embodiments, the SUCI is sent as part of a network access identifier (“NAI”) for the apparatus, the NAI having a format of SUCI@realm. In one embodiment, the network function comprises a proxy AAA server that forwards the NAI to a AAA server based on the realm of the NAI.

In some embodiments, the configuration information for accessing the mobile communication network comprises internet protocol (“IP”) access configuration information for accessing a non-3GPP access point of the mobile communication network. In one embodiment, in response to receiving the challenge packet, the processor 305 performs access authentication with the mobile communication network without performing a full primary network access stratus (“NAS”) authentication.

In one embodiment, the apparatus 300 fails to authenticate with the mobile communication network in response to the authentication response received in the second authentication message comprising an authentication rejection indicator, wherein authentication is rejected in response to the network function not being capable of de-concealing the concealed identifier.

In various embodiments, the processor 305 receives a request for an identifier for the apparatus 305 in response to the apparatus establishing a connection with the non-3GPP access network prior to sending the first authentication message. In some embodiments, the mobile communication network comprises a 4G non-3GPP access network that has access to a 5G unified data management (“UDM”) server, and the apparatus 300 is 4G and 5G capable. In certain embodiments, the network function comprises a 4G 3GPP AAA server in the mobile communication network. The 4G 3GPP AAA server detects the concealed identifier sent in the first authentication message from the apparatus 300.

The memory 310, in one embodiment, is a computer readable storage medium. In some embodiments, the memory 310 includes volatile computer storage media. For example, the memory 310 may include a RAM, including dynamic RAM (“DRAM”), synchronous dynamic RAM (“SDRAM”), and/or static RAM (“SRAM”). In some embodiments, the memory 310 includes non-volatile computer storage media. For example, the memory 310 may include a hard disk drive, a flash memory, or any other suitable non-volatile computer storage device. In some embodiments, the memory 310 includes both volatile and non-volatile computer storage media.

In some embodiments, the memory 310 stores data relating to supporting authentication with a mobile core network using a concealed identity, for example storing security keys, IP addresses, and the like. In certain embodiments, the memory 310 also stores program code and related data, such as an operating system (“OS”) or other controller algorithms operating on the user equipment apparatus 300 and one or more software applications.

The input device 315, in one embodiment, may include any known computer input device including a touch panel, a button, a keyboard, a stylus, a microphone, or the like. In some embodiments, the input device 315 may be integrated with the output device 320, for example, as a touchscreen or similar touch-sensitive display. In some embodiments, the input device 315 includes a touchscreen such that text may be input using a virtual keyboard displayed on the touchscreen and/or by handwriting on the touchscreen. In some embodiments, the input device 315 includes two or more different devices, such as a keyboard and a touch panel.

The output device 320, in one embodiment, may include any known electronically controllable display or display device. The output device 320 may be designed to output visual, audible, and/or haptic signals. In some embodiments, the output device 320 includes an electronic display capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

In certain embodiments, the output device 320 includes one or more speakers for producing sound. For example, the output device 320 may produce an audible alert or notification (e.g., a beep or chime). In some embodiments, the output device 320 includes one or more haptic devices for producing vibrations, motion, or other haptic feedback. In some embodiments, all or portions of the output device 320 may be integrated with the input device 315. For example, the input device 315 and output device 320 may form a touchscreen or similar touch-sensitive display. In other embodiments, all or portions of the output device 320 may be located near the input device 315.

As discussed above, the transceiver 325 communicates with one or more network functions of a mobile communication network via one or more access networks. The transceiver 325 operates under the control of the processor 305 to transmit messages, data, and other signals and also to receive messages, data, and other signals. For example, the processor 305 may selectively activate the transceiver (or portions thereof) at particular times in order to send and receive messages.

The transceiver 325 may include one or more transmitters 330 and one or more receivers 335. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. In one embodiment, the transceiver 325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

In various embodiments, one or more transmitters 330 and/or one or more receivers 335 may be implemented and/or integrated into a single hardware component, such as a multi-transceiver chip, a system-on-a-chip, an ASIC, or other type of hardware component. In certain embodiments, one or more transmitters 330 and/or one or more receivers 335 may be implemented and/or integrated into a multi-chip module. In some embodiments, other components such as the network interface 340 or other hardware components/circuits may be integrated with any number of transmitters 330 and/or receivers 335 into a single chip. In such embodiment, the transmitters 330 and receivers 335 may be logically configured as a transceiver 325 that uses one more common control signals or as modular transmitters 330 and receivers 335 implemented in the same hardware chip or in a multi-chip module.

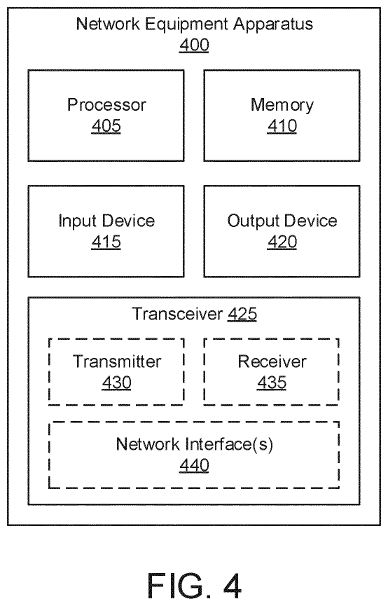

FIG. 4 depicts one embodiment of a network equipment apparatus 400, according to embodiments of the disclosure. In some embodiments, the network equipment apparatus 400 may be one embodiment of a 3GPP AAA server, an HSS, an AUSF, and/or a UDM. Furthermore, network equipment apparatus 400 may include a processor 405, a memory 410, an input device 415, an output device 420, a transceiver 425. In some embodiments, the input device 415 and the output device 420 are combined into a single device, such as a touch screen. In certain embodiments, the network equipment apparatus 400 does not include any input device 415 and/or output device 420.

As depicted, the transceiver 425 includes at least one transmitter 430 and at least one receiver 435. Here, the transceiver 425 communicates with one or more remote units 105. Additionally, the transceiver 425 may support at least one network interface 440, such as the SWa, SWd, N8, and N13 interfaces depicted in FIG. 1. In some embodiments, the transceiver 425 supports a first interface for communicating with a RAN node, a second interface for communicating with one or more network functions in a mobile core network (e.g., a 8GC) and a third interface for communicating with a remote unit 105 (e.g., UE 300).

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 405 executes instructions stored in the memory 410 to perform the methods and routines described herein. The processor 405 is communicatively coupled to the memory 410, the input device 415, the output device 420, and the first transceiver 425.

In various embodiments, the processor 405 controls the network equipment apparatus 400 to implement the above described 3GPP AAA Server behaviors. In one embodiment, the processor 405 receives (e.g., via transceiver 425) a first authentication message from a network function to authenticate a remote unit 105, e.g., UE 300, with a mobile communication network via a non-3GPP access network. Here, the first authentication message comprises an identifier for the remote unit 105 and an authentication type. In certain embodiments, the processor 405 detects that the identifier is a concealed identifier for the remote unit 105. Here, the concealed identifier indicates that the remote unit 105 is 5G capable.

In one embodiment, the processor 405 creates an authentication vector request message comprising the concealed identifier and an authentication method. Here, the authentication type may specify the authentication method. In various embodiments, the processor 405 sends (e.g., via the transceiver 425) the authentication vector request message to the network function. Here, the network function de-conceals the concealed identifier to retrieve a permanent identifier for the remote unit 105. In some embodiments, the processor 405 receives an authentication vector response message from the network function. The authentication vector response message may include an authentication vector and the permanent identifier for the remote unit 105.

In one embodiment, the processor 405 detects the concealed identifier in a username portion of a network access identifier (“NAI”) that is received as part of the first authentication message instead of an international mobile subscriber identity (“IMSI”). In certain embodiments, the concealed identifier comprises a subscription concealed identifier (“SUCI”) for the remote unit 105. In various embodiments, the network function that the authentication vector request message is sent to comprises a home subscriber server (“HSS”).

In one embodiment, the network function that the authentication vector request message is sent to comprises a unified data management (“UDM”) server. In some embodiments, the processor 405 selects the UDM server based on routing information associated with the concealed identifier. In various embodiments, the apparatus 400 is enhanced with a service based interface (“SBI”) to represent an authentication server function (“AUSF”) and communicate directly with the UDM server.

In one embodiment, the authentication vector request message comprises one of a Nudm_UEAuthentication_Get request message in response to the apparatus hosting an SBI to communicate with the UDM and an authentication and key agreement (“AKA”) authentication vector (“AV”) request message in response to the apparatus hosting a AAA protocol interface with the UDM.

In certain embodiments, the network function to which the authentication vector request message is sent comprises an authentication server function (“AUSF”). In one embodiment, the authentication vector request message comprises one of a Nausf_UEAuthentication_Authenticate request message (e.g., in response to the apparatus 400 hosting a service based interface (“SBI”) with the AUSF, the apparatus 400 acting as an AMF), and an authentication and key agreement (“AKA”) authentication vector (“AV”) request message (e.g., in response to the apparatus 400 hosting a AAA protocol interface with the AUSF, the apparatus 400 acting as a AAA proxy). In certain embodiments, the permanent identifier in the received authentication vector response message comprises a subscription permanent identifier (“SUPI”) for the remote unit 105.

In various embodiments, the processor 405 controls the network equipment apparatus 400 to implement the above described HSS behaviors. In one embodiment, the processor 405 receives (e.g., via transceiver 415) an authentication vector request message from a first network function to authenticate a remote unit 105, e.g., UE 300, with a mobile communication network via a non-3GPP access network. Here, the authentication vector request message includes an identifier for the remote unit 105 and an authentication type specifying an authentication method.

In one embodiment, the processor 405 detects that the identifier is a concealed identifier for the remote unit 105. Here, the concealed identifier indicates that the remote unit 105 is 5G capable. In further embodiments, the processor 405 selects a second network function based on the concealed identifier. Here, the second network function is configured to de-conceal the concealed identifier.

The processor 405, in some embodiments, sends (e.g., via transceiver 425) the authentication vector request message to the second network function for requesting an authentication vector associated with the concealed identifier and the authentication type. In certain embodiments, the processor 405 receives an authentication vector response message from the second network function. Here, the authentication vector response message includes the authentication vector and a permanent identifier for the remote unit 105.

In one embodiment, the first network function comprises a AAA server and the second network function comprises a unified data management (“UDM”) server. In further embodiments, the processor 405 connects to the UDM server for de-concealing the concealed identifier by sending an identity request that comprises the concealed identifier. In one embodiment, the processor 405 sends an authentication and key agreement (“AKA”) authentication vector (“AV”) request message to the UDM server for de-concealing the concealed identifier.

In various embodiments, the processor 405 sends an identity request message to the UDM server for de-concealing the concealed identifier. In certain embodiments, the concealed identifier in the authentication vector request message comprises a subscription concealed identifier (“SUCI”) for the remote unit 105. In one embodiment, the permanent identifier in the received authentication vector response message comprises a subscription permanent identifier (“SUPI”) for the remote unit 105.

In various embodiments, the processor 405 controls the network equipment apparatus 400 to implement the above described UDM behaviors. In one embodiment, the processor 405 receives (e.g., via transceiver 425) an authentication vector request message from a network function to authenticate a remote unit 105, e.g., UE 300, with the mobile communication network via a non-3GPP access network. Here, the authentication vector request message includes an identifier for the remote unit 105 and an authentication type.

In one embodiment, the processor 405 detects that the identifier is a concealed identifier for the remote unit 105. Here, the concealed identifier indicates that the remote unit 105 is 5G capable. In various embodiments, the processor 405 de-conceals the concealed identifier to determine a permanent identifier for the remote unit 105. In certain embodiments, the processor 405 creates an authentication vector response message comprising the de-concealed permanent identifier for the remote unit 105 and an authentication method, where the authentication type specifies an authentication method. In various embodiments, the processor 405 sends (e.g., via transceiver 425) the authentication vector response message to the network function.

In one embodiment, the processor 405 verifies the received authentication vector request message prior to de-concealing the concealed identifier. In certain embodiments, the processor 405 queries a subscription identifier de-concealing function (“SIDF”) to de-conceal the concealed identifier. In one embodiment, the authentication vector request message further comprises an authentication method. Here, the processor 405 generates the authentication vector response message according to the received authentication method.

In certain embodiments, the network function comprises a home subscriber server (“HSS”) and the processor 405 sends the de-concealed identifier to the HSS in an identity response in response to the authentication vector request message comprising an identity request. In one embodiment, the network function comprises a 3GPP AAA server and the processor 405 sends the de-concealed identifier to the 3GPP AAA server in an authentication vector response message. In further embodiments, the network function comprises an authentication server function (“AUSF”) and the processor 405 sends the de-concealed identifier to the AUSF in an authentication vector response message.

In one embodiment, the permanent identifier in the received authentication vector response message comprises a subscription permanent identifier (“SUPI”) for the remote unit 105. In certain embodiments, the processor 405 formats the SUPI in an international mobile subscriber identity (“IMSI”) format. In one embodiment, the processor 405 creates the authentication vector response message according to an authentication method specified in the authentication type in the received authentication vector request message.

In various embodiments, the processor 405 controls the network equipment apparatus 400 to implement the above described AUSF behaviors. In one embodiment, the processor 405 receives (e.g., via transceiver 425) an authentication vector request message from a network function to authenticate a remote unit 105, e.g., UE 300, with the mobile communication network via a non-3GPP access network. Here, the authentication vector request message includes an identifier for the remote unit 105.

In one embodiment, the processor 405 detects that the identifier is a concealed identifier for the remote unit 105. Here, the concealed identifier indicates that the remote unit 105 is 5G capable. In some embodiments, the processor 405 selects a network function for de-concealing the concealed identifier based on a routing identifier of the concealed identifier.

In one embodiment, the processor 405 sends (e.g., via transceiver 425) an authentication vector request message to the network function. Here, the network function de-conceals the concealed identifier to retrieve a permanent identifier for the remote unit 105. In further embodiments, the processor 405 receives an authentication vector response message from the network function. Here, the authentication vector response message includes an authentication vector and the permanent identifier for the remote unit 105.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data relating to supporting authentication with a mobile core network using a concealed identity, for example storing security keys, IP addresses, UE contexts, and the like. In certain embodiments, the memory 410 also stores program code and related data, such as an operating system (“OS”) or other controller algorithms operating on the network equipment apparatus 400 and one or more software applications.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, may include any known electronically controllable display or display device. The output device 420 may be designed to output visual, audible, and/or haptic signals. In some embodiments, the output device 420 includes an electronic display capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all or portions of the output device 420 may be integrated with the input device 415. For example, the input device 415 and output device 420 may form a touchscreen or similar touch-sensitive display. In other embodiments, all or portions of the output device 420 may be located near the input device 415.

As discussed above, the transceiver 425 may communicate with one or more remote units 105 and/or with one or more interworking functions that provide access to one or more PLMNs. The transceiver 425 may also communicate with one or more network functions (e.g., in the mobile core network 140). The transceiver 425 operates under the control of the processor 405 to transmit messages, data, and other signals and also to receive messages, data, and other signals. For example, the processor 405 may selectively activate the transceiver (or portions thereof) at particular times in order to send and receive messages.

The transceiver 425 may include one or more transmitters 430 and one or more receivers 435. In certain embodiments, the one or more transmitters 430 and/or the one or more receivers 435 may share transceiver hardware and/or circuitry. For example, the one or more transmitters 430 and/or the one or more receivers 435 may share antenna(s), antenna tuner(s), amplifier(s), filter(s), oscillator(s), mixer(s), modulator/demodulator(s), power supply, and the like. In one embodiment, the transceiver 425 implements multiple logical transceivers using different communication protocols or protocol stacks, while using common physical hardware.

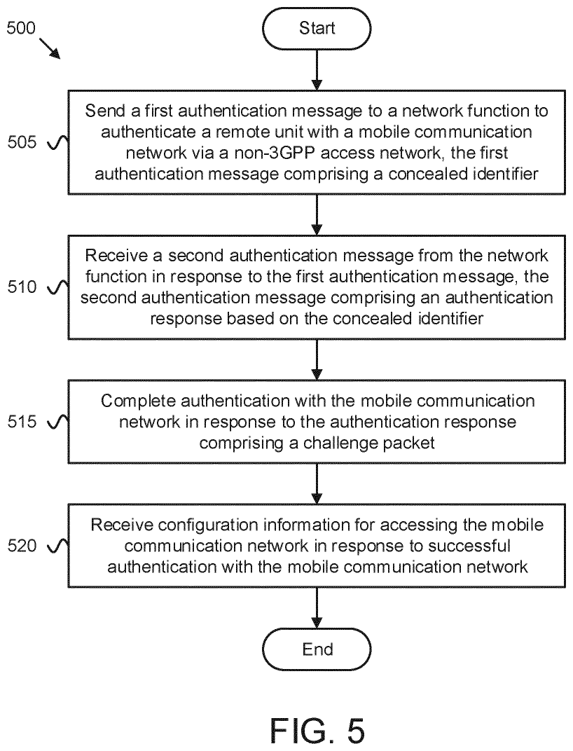

FIG. 5 depicts one embodiment of a method 500 for supporting authentication with a mobile core network using a concealed identity, according to embodiments of the disclosure. In various embodiments, the method 500 is performed by a UE, such as the remote unit 105, UE 205, and/or user equipment apparatus 300, described above. In some embodiments, the method 500 is performed by a processor, such as a microcontroller, a microprocessor, a CPU, a GPU, an auxiliary processing unit, a FPGA, or the like.

The method 500 begins and sends 505 a first authentication message to a network function to authenticate a remote unit 105 with a mobile communication network via a non-3GPP access network 207. The first authentication message includes a concealed identifier.

The method 500 includes receiving 510 a second authentication message from the network function in response to the first authentication message. The second authentication message includes an authentication response based on the concealed identifier.

The method 500 completing 515 authentication with the mobile communication network in response to the authentication response comprising a challenge packet.

The method 500 includes receiving 520 configuration information for accessing the mobile communication network in response to successful authentication with the mobile communication network. The method 500 ends.

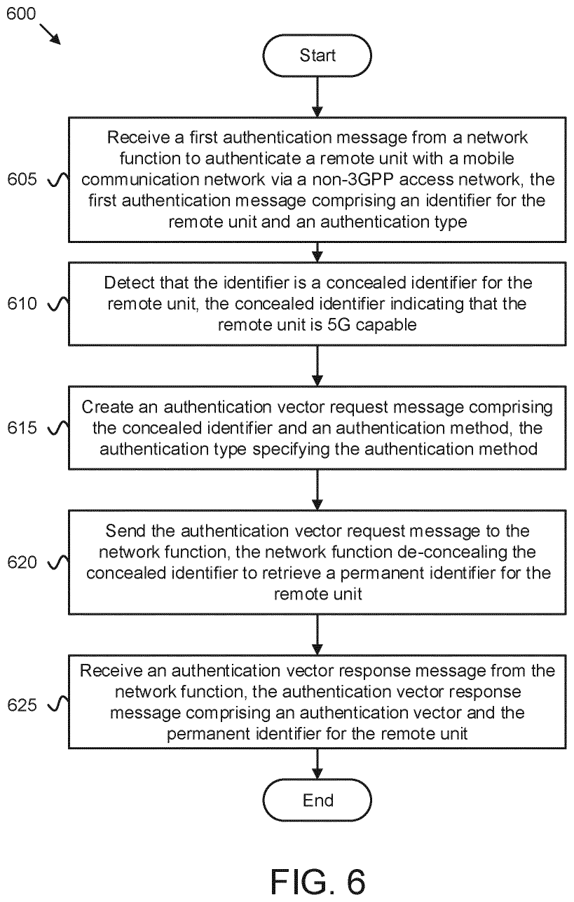

FIG. 6 depicts one embodiment of a method 600 for supporting authentication with a mobile core network using a concealed identity, according to embodiments of the disclosure. In various embodiments, the method 600 is performed by a AAA Server, such as the 3GPP AAA Server 217 and/or network equipment apparatus 400, described above. In some embodiments, the method 600 is performed by a processor, such as a microcontroller, a microprocessor, a CPU, a GPU, an auxiliary processing unit, a FPGA, or the like.

The method 600 begins and receives 605 a first authentication message from a network function to authenticate a remote unit 105 with a mobile communication network via a non-3GPP access network 207. The first authentication message includes an identifier for the remote unit 105 and an authentication type. The method 600 includes detecting 610 that the identifier is a concealed identifier for the remote unit 105. The concealed identifier indicates that the remote unit 105 is 5G capable.

The method 600 includes creating 615 an authentication vector request message comprising the concealed identifier and an authentication method, the authentication type specifying the authentication method. The method 600 includes sending 620 the authentication vector request message to the network function. Here, the network function de-conceals the concealed identifier to retrieve a permanent identifier for the remote unit 105. The method 600 includes receiving 625 an authentication vector response message from the network function. Here, the authentication vector response message includes an authentication vector and the permanent identifier for the remote unit 105. The method 600 ends.

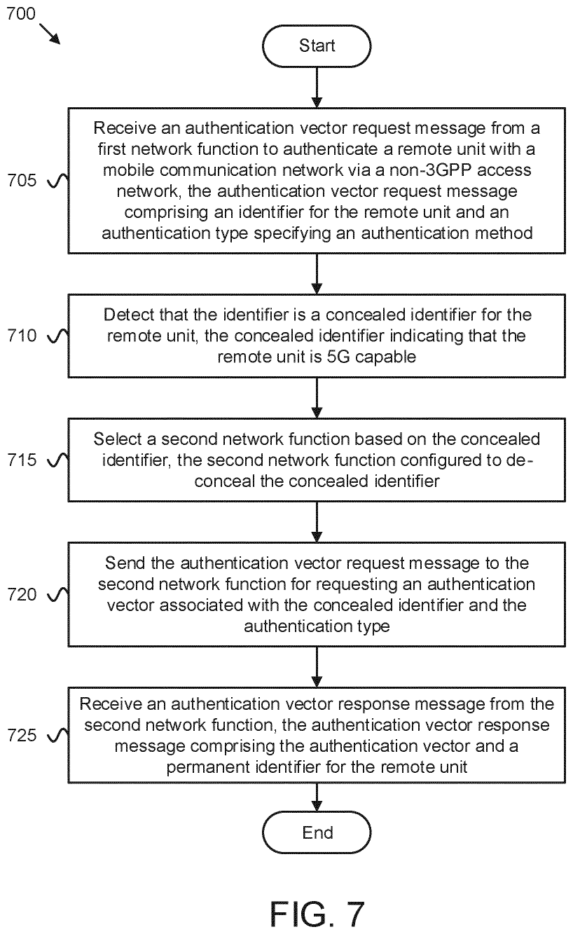

FIG. 7 depicts one embodiment of a method 700 for supporting authentication with a mobile core network using a concealed identity, according to embodiments of the disclosure. In various embodiments, the method 700 is performed by an HSS, such as the HSS 219 and/or network equipment apparatus 400, described above. In some embodiments, the method 700 is performed by a processor, such as a microcontroller, a microprocessor, a CPU, a GPU, an auxiliary processing unit, a FPGA, or the like.

The method 700 begins and receives 705 an authentication vector request message from a first network function to authenticate a remote unit 105 with a mobile communication network via a non-3GPP access network 207. Here, the authentication vector request message includes an identifier for the remote unit 105 and an authentication type specifying the authentication method.

The method 700 includes detecting 710 that the identifier is a concealed identifier for the remote unit 105. The concealed identifier indicates that the remote unit 105 is 5G capable. The method 700 selects 715 a second network function based on the concealed identifier. Here, the second network function is configured to de-conceal the concealed identifier.

The method 700 sends 720 the authentication vector request message to the second network function for requesting an authentication vector associated with the concealed identifier and the authentication type. The method 700 includes receiving 725 an authentication vector response message from the second network function. Here, the authentication vector response message includes the authentication vector and a permanent identifier for the remote unit 105. The method 700 ends.

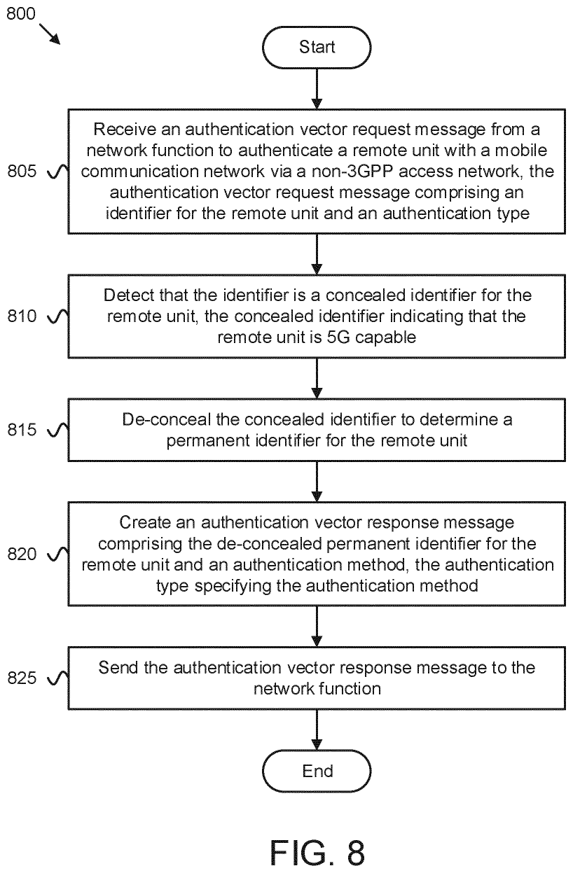

FIG. 8 depicts one embodiment of a method 800 for supporting authentication with a mobile core network using a concealed identity, according to embodiments of the disclosure. In various embodiments, the method 800 is performed by a UDM, such as the UDM 221, and/or network equipment apparatus 400, described above. In some embodiments, the method 800 is performed by a processor, such as a microcontroller, a microprocessor, a CPU, a GPU, an auxiliary processing unit, a FPGA, or the like.

The method 800 begins and receives 805 an authentication vector request message from a network function to authenticate a remote unit 105 with a mobile communication network via a non-3GPP access network 207. Here, the authentication vector request message includes an identifier for the remote unit 105 and an authentication type. The method 800 detects 810 that the identifier is a concealed identifier for the remote unit 105. Here, the concealed identifier indicates that the remote unit is 5G capable.

The method 800 de-conceals 815 the concealed identifier to determine a permanent identifier for the remote unit 105. The method 800 includes creating 820 an authentication vector response message comprising the de-concealed permanent identifier for the remote unit 105 and an authentication method, where the authentication type specifies the authentication method. The method 800 sends 825 the authentication vector response message to the network function. The method 800 ends.

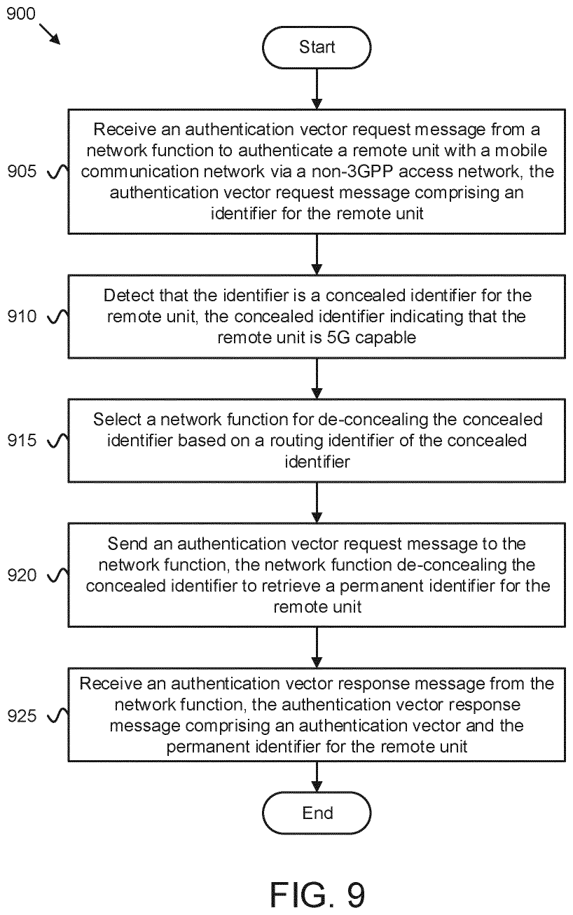

FIG. 9 depicts one embodiment of a method 900 for supporting authentication with a mobile core network using a concealed identity, according to embodiments of the disclosure. In various embodiments, the method 900 is performed by an AUSF, such as the AUSF 223 and/or network equipment apparatus 400, described above. In some embodiments, the method 900 is performed by a processor, such as a microcontroller, a microprocessor, a CPU, a GPU, an auxiliary processing unit, a FPGA, or the like.

The method 900 begins and receives 905 an authentication vector request message from a network function to authenticate a remote unit 105 with a mobile communication network via a non-3GPP access network 207. Here, the authentication vector request message includes an identifier for the remote unit 105.

The method 900 includes detecting 910 that the identifier is a concealed identifier for the remote unit 105. The concealed identifier indicating that the remote unit 105 is 5G capable. The method 900 includes selecting 915 a network function for de-concealing the concealed identifier based on a routing identifier of the concealed identifier.

The method 900 includes sending 920 an authentication vector request message to the network function. The network function de-conceals the concealed identifier to retrieve a permanent identifier for the remote unit 105. The method 900 includes receiving 925 an authentication vector response message from the network function. Here, the authentication vector response message includes an authentication vector and the permanent identifier for the remote unit 105. The method 900 ends.

Disclosed herein is a first apparatus for supporting authentication with a mobile core network using a concealed identity, according to embodiments of the disclosure. The first apparatus may be implemented by a UE, such as the remote unit 105, UE 205, and/or user equipment apparatus 300. The first apparatus includes a transceiver that communicates with a non-3GPP access network and a processor that establishes connectivity with a first access point in the non-3GPP access network.

Here, the processor sends a first authentication message to a network function to authenticate with the mobile communication network via the non-3GPP access network. The first authentication message includes a concealed identifier for the apparatus. In certain embodiments, the processor receives a second authentication message from the network function in response to the first authentication message. Here, the second authentication message includes an authentication response based on the concealed identifier.

In further embodiments, the processor completes authentication with the mobile communication network in response to the authentication response comprising a challenge packet and receives configuration information for accessing the mobile communication network in response to successful authentication with the mobile communication network.

In one embodiment, the concealed identifier for the apparatus that is sent in the first authentication message to the network function comprises a subscription concealed identifier. In certain embodiments, the SUCI is sent as part of a network access identifier (“NAI”) for the apparatus, the NAI having a format of SUCI@realm. In one embodiment, the network function comprises a proxy AAA server that forwards the NAI to a AAA server based on the realm of the NAI.

In some embodiments, the configuration information for accessing the mobile communication network comprises internet protocol (“IP”) access configuration information for accessing a non-3GPP access point of the mobile communication network. In one embodiment, in response to receiving the challenge packet, the processor performs access authentication with the mobile communication network without performing a full primary network access stratus (“NAS”) authentication.

In one embodiment, the apparatus fails to authenticate with the mobile communication network in response to the authentication response received in the second authentication message comprising an authentication rejection indicator, wherein authentication is rejected in response to the network function not being capable of de-concealing the concealed identifier.

In various embodiments, the processor receives a request for an identifier for the apparatus in response to the apparatus establishing a connection with the non-3GPP access network prior to sending the first authentication message. In some embodiments, the mobile communication network comprises a 4G non-3GPP access network that has access to a 5G unified data management (“UDM”) server, and the apparatus is 4G and 5G capable. In certain embodiments, the network function comprises a 4G 3GPP AAA server in the mobile communication network. The 4G 3GPP AAA server detects the concealed identifier sent in the first authentication message from the apparatus.

Disclosed herein is a first method for supporting authentication with a mobile core network using a concealed identity, according to embodiments of the disclosure. The first method may be performed by a UE, such as the remote unit 105, UE 205, and/or user equipment apparatus 300. The first method includes sending a first authentication message to a network function to authenticate with a mobile communication network via a non-3GPP access network. The first authentication message includes a concealed identifier for the apparatus. In certain embodiments, the first method receives a second authentication message from the network function in response to the first authentication message. Here, the second authentication message includes an authentication response based on the concealed identifier.

In further embodiments, the first method completes authentication with the mobile communication network in response to the authentication response comprising a challenge packet and receives configuration information for accessing the mobile communication network in response to successful authentication with the mobile communication network.

In one embodiment, the concealed identifier for the apparatus that is sent in the first authentication message to the network function comprises a subscription concealed identifier. In certain embodiments, the SUCI is sent as part of a network access identifier (“NAI”) for the apparatus, the NAI having a format of SUCI@realm. In one embodiment, the network function comprises a proxy AAA server that forwards the NAI to a AAA server based on the realm of the NAI.

In some embodiments, the configuration information for accessing the mobile communication network comprises internet protocol (“IP”) access configuration information for accessing a non-3GPP access point of the mobile communication network. In one embodiment, in response to receiving the challenge packet, the first method performs access authentication with the mobile communication network without performing a full primary network access stratus (“NAS”) authentication.

In one embodiment, the UE fails to authenticate with the mobile communication network in response to the authentication response received in the second authentication message comprising an authentication rejection indicator, wherein authentication is rejected in response to the network function not being capable of de-concealing the concealed identifier.

In various embodiments, the first method receives a request for an identifier for the apparatus in response to the apparatus establishing a connection with the non-3GPP access network prior to sending the first authentication message. In some embodiments, the mobile communication network comprises a 4G non-3GPP access network that has access to a 5G unified data management (“UDM”) server, and the apparatus is 4G and 5G capable. In certain embodiments, the network function comprises a 4G 3GPP AAA server in the mobile communication network. The 4G 3GPP AAA server detects the concealed identifier sent in the first authentication message from the apparatus.

Disclosed herein is a second apparatus for supporting authentication with a mobile core network using a concealed identity, according to embodiments of the disclosure. The second apparatus may be implemented by a AAA server, such as the 3GPP AAA server 217 and/or network equipment apparatus 400. The second apparatus includes a network interface that communicates with a mobile communication network and a processor that establishes connectivity with a first access point in the non-3GPP access network.

In one embodiment, the processor receives a first authentication message from a network function to authenticate a remote unit with the mobile communication network via a non-3GPP access network. Here, the first authentication message comprises an identifier for the remote unit and an authentication type. In certain embodiments, the processor detects that the identifier is a concealed identifier for the remote unit. Here, the concealed identifier indicates that the remote unit is 5G capable.

In one embodiment, the processor creates an authentication vector request message comprising the concealed identifier and an authentication method, where the authentication type specifies the authentication method. In various embodiments, the processor sends the authentication vector request message to the network function. Here, the network function de-conceals the concealed identifier to retrieve a permanent identifier for the remote unit. In some embodiments, the processor receives an authentication vector response message from the network function, the authentication vector response message comprising an authentication vector and the permanent identifier for the remote unit.

In one embodiment, the processor detects the concealed identifier in a username portion of a network access identifier (“NAI”) that is received as part of the first authentication message instead of an international mobile subscriber identity (“IMSI”). In certain embodiments, the concealed identifier comprises a subscription concealed identifier (“SUCI”) for the remote unit. In various embodiments, the network function that the authentication vector request message is sent to comprises a home subscriber server (“HSS”).

In one embodiment, the network function that the authentication vector request message is sent to comprises a unified data management (“UDM”) server. In some embodiments, the processor selects the UDM server based on routing information associated with the concealed identifier. In various embodiments, the apparatus is enhanced with a service based interface (“SBI”) to represent an authentication server function (“AUSF”) and communicate directly with the UDM server.

In one embodiment, the authentication vector request message comprises one of a Nudm_UEAuthentication_Get request message in response to the apparatus hosting an SBI to communicate with the UDM and an authentication and key agreement (“AKA”) authentication vector (“AV”) request message in response to the apparatus hosting a AAA protocol interface with the UDM.

In certain embodiments, the network function that the authentication vector request message is sent to comprises an authentication server function (“AUSF”). In one embodiment, the authentication vector request message comprises one of a Nausf_UEAuthentication_Authenticate request message in response to the apparatus hosting a service based interface (“SBI”) with the AUSF, the apparatus acting as an access and mobility management function (“AMF”), and an authentication and key agreement (“AKA”) authentication vector (“AV”) request message in response to the apparatus hosting a AAA protocol interface with the AUSF, the apparatus acting as a AAA proxy. In certain embodiments, the permanent identifier in the received authentication vector response message comprises a subscription permanent identifier (“SUPI”) for the remote unit.

Disclosed herein is a second method for supporting authentication with a mobile core network using a concealed identity, according to embodiments of the disclosure. The second method may be performed by a AAA server, such as the 3GPP AAA server 217 and/or network equipment apparatus 400. In one embodiment, the second method receives a first authentication message from a network function to authenticate a remote unit with a mobile communication network via a non-3GPP access network. Here, the first authentication message comprises an identifier for the remote unit. In certain embodiments, the second method detects that the identifier is a concealed identifier for the remote unit and an authentication type. Here, the concealed identifier indicates that the remote unit is 5G capable.

In one embodiment, the second method creates an authentication vector request message comprising the concealed identifier and an authentication method, where the authentication type specifies the authentication method. In various embodiments, the second method sends the authentication vector request message to the network function. Here, the network function de-conceals the concealed identifier to retrieve a permanent identifier for the remote unit. In some embodiments, the second method receives an authentication vector response message from the network function, the authentication vector response message comprising an authentication vector and the permanent identifier for the remote unit.

In one embodiment, the second method detects the concealed identifier in a username portion of a network access identifier (“NAI”) that is received as part of the first authentication message instead of an international mobile subscriber identity (“IMSI”). In certain embodiments, the concealed identifier comprises a subscription concealed identifier (“SUCI”) for the remote unit. In various embodiments, the network function that the authentication vector request message is sent to comprises a home subscriber server (“HSS”).

In one embodiment, the network function that the authentication vector request message is sent to comprises a unified data management (“UDM”) server. In some embodiments, the second method selects the UDM server based on routing information associated with the concealed identifier. In various embodiments, the apparatus is enhanced with a service based interface (“SBI”) to represent an authentication server function (“AUSF”) and communicate directly with the UDM server.

In one embodiment, the authentication vector request message comprises one of a Nudm_UEAuthentication_Get request message in response to the apparatus hosting an SBI to communicate with the UDM and an authentication and key agreement (“AKA”) authentication vector (“AV”) request message in response to the apparatus hosting a AAA protocol interface with the UDM.

In certain embodiments, the network function that the authentication vector request message is sent to comprises an authentication server function (“AUSF”). In one embodiment, the authentication vector request message comprises one of a Nausf_UEAuthentication_Authenticate request message in response to the apparatus hosting a service based interface (“SBI”) with the AUSF, the apparatus acting as an access and mobility management function (“AMF”), and an authentication and key agreement (“AKA”) authentication vector (“AV”) request message in response to the apparatus hosting a AAA protocol interface with the AUSF, the apparatus acting as a AAA proxy. In certain embodiments, the permanent identifier in the received authentication vector response message comprises a subscription permanent identifier (“SUPI”) for the remote unit.

Disclosed herein is a third apparatus for supporting authentication with a mobile core network using a concealed identity, according to embodiments of the disclosure. The third apparatus may be implemented by an HSS server, such as the HSS 219 and/or network equipment apparatus 400. The third apparatus includes a network interface that communicates with a mobile communication network and a processor that receives an authentication vector request message from a first network function to authenticate a remote unit with the mobile communication network via a non-3GPP access network. Here, the authentication vector request message includes an identifier for the remote unit and an authentication type specifying an authentication method.

In one embodiment, the processor detects that the identifier is a concealed identifier for the remote unit. Here, the concealed identifier indicates that the remote unit is 5G capable. In further embodiments, the processor selects a second network function based on the concealed identifier. Here, the second network function is configured to de-conceal the concealed identifier.

The processor, in some embodiments, sends the authentication vector request message to the second network function for requesting an authentication vector associated with the concealed identifier and the authentication type. In certain embodiments, the processor receives an authentication vector response message from the second network function. Here, the authentication vector response message includes the authentication vector and a permanent identifier for the remote unit.

In one embodiment, the first network function comprises a AAA server and the second network function comprises a unified data management (“UDM”) server. In further embodiments, the processor connects to the UDM server for de-concealing the concealed identifier by sending an identity request that comprises the concealed identifier. In one embodiment, the processor sends an authentication and key agreement (“AKA”) authentication vector (“AV”) request message to the UDM server for de-concealing the concealed identifier.

In various embodiments, the processor sends an identity request message to the UDM server for de-concealing the concealed identifier. In certain embodiments, the concealed identifier in the authentication vector request message comprises a subscription concealed identifier (“SUCI”) for the remote unit. In one embodiment, the permanent identifier in the received authentication vector response message comprises a subscription permanent identifier (“SUPI”) for the remote unit.

Disclosed herein is a third method for supporting authentication with a mobile core network using a concealed identity, according to embodiments of the disclosure. The third method may be performed by an HSS server, such as the HSS 219 and/or network equipment apparatus 400. The third method, in one embodiment, receives an authentication vector request message from a first network function to authenticate a remote unit with a mobile communication network via a non-3GPP access network. Here, the authentication vector request message includes an identifier for the remote unit and an authentication type specifying an authentication method.

In one embodiment, the third method detects that the identifier is a concealed identifier for the remote unit. Here, the concealed identifier indicates that the remote unit is 5G capable. In further embodiments, the third method selects a second network function based on the concealed identifier and the authentication type. Here, the second network function is configured to de-conceal the concealed identifier.

The third method, in some embodiments, sends the authentication vector request message to the second network function for requesting an authentication vector associated with the concealed identifier. In certain embodiments, the third method receives an authentication vector response message from the second network function. Here, the authentication vector response message includes the authentication vector and a permanent identifier for the remote unit.

In one embodiment, the first network function comprises a AAA server and the second network function comprises a unified data management (“UDM”) server. In further embodiments, the third method connects to the UDM server for de-concealing the concealed identifier by sending an identity request that comprises the concealed identifier. In one embodiment, the third method sends an authentication and key agreement (“AKA”) authentication vector (“AV”) request message to the UDM server for de-concealing the concealed identifier.

In various embodiments, the third method sends an identity request message to the UDM server for de-concealing the concealed identifier. In certain embodiments, the concealed identifier in the authentication vector request message comprises a subscription concealed identifier (“SUCI”) for the remote unit. In one embodiment, the permanent identifier in the received authentication vector response message comprises a subscription permanent identifier (“SUPI”) for the remote unit.

Disclosed herein is a fourth apparatus for supporting authentication with a mobile core network using a concealed identity, according to embodiments of the disclosure. The fourth apparatus may be implemented by a UDM, such as the UDM 221 and/or network equipment apparatus 400. The fourth apparatus includes a network interface that communicates with a mobile communication network and a processor that receives an authentication vector request message from a network function to authenticate a remote unit with the mobile communication network via a non-3GPP access network. Here, the authentication vector request message includes an identifier for the remote unit and an authentication type.

In one embodiment, the processor detects that the identifier is a concealed identifier for the remote unit. Here, the concealed identifier indicates that the remote unit is 5G capable. In various embodiments, the processor de-conceals the concealed identifier to determine a permanent identifier for the remote unit. In certain embodiments, the processor creates an authentication vector response message comprising the de-concealed permanent identifier for the remote unit and an authentication method, where the authentication type specifies the authentication method. In various embodiments, the processor sends the authentication vector response message to the network function.

In one embodiment, the processor verifies the received authentication vector request message prior to de-concealing the concealed identifier. In certain embodiments, the processor queries a subscription identifier de-concealing function (“SIDF”) to de-conceal the concealed identifier. In one embodiment, the authentication vector request message further comprises an authentication method. Here, the processor generates the authentication vector response message according to the received authentication method.

In certain embodiments, the network function comprises a home subscriber server (“HSS”) and the processor sends the de-concealed identifier to the HSS in an identity response in response to the authentication vector request message comprising an identity request. In one embodiment, the network function comprises a 3GPP AAA server and the processor sends the de-concealed identifier to the 3GPP AAA server in an authentication vector response message. In further embodiments, the network function comprises an authentication server function (“AUSF”) and the processor sends the de-concealed identifier to the AUSF in an authentication vector response message.

In one embodiment, the permanent identifier in the received authentication vector response message comprises a subscription permanent identifier (“SUPI”) for the remote unit. In certain embodiments, the processor formats the SUPI in an international mobile subscriber identity (“IMSI”) format. In one embodiment, the processor creates the authentication vector response message according to an authentication method specified in the received authentication vector request message.

Disclosed herein is a fourth method for supporting authentication with a mobile core network using a concealed identity, according to embodiments of the disclosure. The fourth method may be performed by a UDM, such as the UDM 221 and/or network equipment apparatus 400. The fourth method, in one embodiment, in receives an authentication vector request message from a network function to authenticate a remote unit with a mobile communication network via a non-3GPP access network. Here, the authentication vector request message includes an identifier for the remote unit and an authentication type.

In one embodiment, the fourth method detects that the identifier is a concealed identifier for the remote unit. Here, the concealed identifier indicates that the remote unit is 5G capable. In various embodiments, the fourth method de-conceals the concealed identifier to determine a permanent identifier for the remote unit. In certain embodiments, the fourth method creates an authentication vector response message comprising the de-concealed permanent identifier for the remote unit and an authentication method, where the authentication type specifies the authentication method. In various embodiments, the fourth method sends the authentication vector response message to the network function.

In one embodiment, the fourth method verifies the received authentication vector request message prior to de-concealing the concealed identifier. In certain embodiments, the fourth method queries a subscription identifier de-concealing function (“SIDF”) to de-conceal the concealed identifier. In one embodiment, the authentication vector request message further comprises an authentication method. Here, the fourth method generates the authentication vector response message according to the received authentication method.

In certain embodiments, the network function comprises a home subscriber server (“HSS”) and the processor sends the de-concealed identifier to the HSS in an identity response in response to the authentication vector request message comprising an identity request. In one embodiment, the network function comprises a 3GPP AAA server and the fourth method sends the de-concealed identifier to the 3GPP AAA server in an authentication vector response message. In further embodiments, the network function comprises an authentication server function (“AUSF”) and the fourth method sends the de-concealed identifier to the AUSF in an authentication vector response message.

In one embodiment, the permanent identifier in the received authentication vector response message comprises a subscription permanent identifier (“SUPI”) for the remote unit. In certain embodiments, the fourth method formats the SUPI in an international mobile subscriber identity (“IMSI”) format.

Disclosed herein is a fifth apparatus for supporting authentication with a mobile core network using a concealed identity, according to embodiments of the disclosure. The fifth apparatus may be implemented by an AUSF, such as the AUSF 223 and/or network equipment apparatus 400. The fifth apparatus includes a network interface that communicates with a mobile communication network and a processor that receives an authentication vector request message from a network function to authenticate a remote unit with the mobile communication network via a non-3GPP access network. Here, the authentication vector request message includes an identifier for the remote unit.

In one embodiment, the processor detects that the identifier is a concealed identifier for the remote unit. Here, the concealed identifier indicates that the remote unit is 5G capable. In some embodiments, the processor selects a network function for de-concealing the concealed identifier based on a routing identifier of the concealed identifier.

In one embodiment, the processor sends an authentication vector request message to the network function. Here, the network function de-conceals the concealed identifier to retrieve a permanent identifier for the remote unit. In further embodiments, the processor receives an authentication vector response message from the network function. Here, the authentication vector response message includes an authentication vector and the permanent identifier for the remote unit.

Disclosed herein is a fifth method for supporting authentication with a mobile core network using a concealed identity, according to embodiments of the disclosure. The fifth method may be performed by an AUSF, such as the AUSF 223 and/or network equipment apparatus 400. The fifth method, in one embodiment, receives an authentication vector request message from a network function to authenticate a remote unit with the mobile communication network via a non-3GPP access network. Here, the authentication vector request message includes an identifier for the remote unit.

In one embodiment, the fifth method detects that the identifier is a concealed identifier for the remote unit. Here, the concealed identifier indicates that the remote unit is 5G capable. In some embodiments, the fifth method selects a network function for de-concealing the concealed identifier based on a routing identifier of the concealed identifier.

In one embodiment, the fifth method sends an authentication vector request message to the network function. Here, the network function de-conceals the concealed identifier to retrieve a permanent identifier for the remote unit. In further embodiments, the fifth method receives an authentication vector response message from the network function. Here, the authentication vector response message includes an authentication vector and the permanent identifier for the remote unit.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-20. (canceled)

21. An apparatus comprising:
a processor that:
a memory coupled to the processor, the processor configured to cause the apparatus to:
send a first authentication message to a network function to authenticate with a mobile communication network via a non-3GPP access network, the first authentication message comprising a concealed identifier for the apparatus;
receive a second authentication message from the network function in response to the first authentication message, the second authentication message comprising an authentication response based on the concealed identifier;
complete authentication with the mobile communication network in response to the authentication response comprising a challenge packet; and
receive configuration information for accessing the mobile communication network in response to successful authentication with the mobile communication network.

22. The apparatus of claim 21, wherein the concealed identifier for the apparatus that is sent in the first authentication message to the network function comprises a subscription concealed identifier (“SUCI”).

23. The apparatus of claim 22, wherein the SUCI is sent as part of a network access identifier (“NAI”) for the apparatus, the NAI having a format of ‘SUCI@realm.’

24. The apparatus of claim 21, wherein the configuration information for accessing the mobile communication network comprises internet protocol (“IP”) access configuration information for accessing a non-3GPP access point of the mobile communication network.

25. The apparatus of claim 21, wherein, in response to receiving the challenge packet, the processor is configured to cause the apparatus to perform access authentication with the mobile communication network without performing a full primary network access stratus (“NAS”) authentication.

26. The apparatus of claim 21, wherein the apparatus fails to authenticate with the mobile communication network in response to the authentication response comprising an authentication rejection indicator, wherein authentication is rejected in response to the network function not being capable of de-concealing the concealed identifier.

27. The apparatus of claim 21, wherein the processor is configured to cause the apparatus to receive a request for an identifier for the apparatus in response to the apparatus establishing a connection with the non-3GPP access network prior to sending the first authentication message.

28. The apparatus of claim 21, wherein:
the mobile communication network comprises a 4G non-3GPP access network that has access to a 5G unified data management (“UDM”) server, and the apparatus is 4G and 5G capable; and
the network function comprises a 4G 3GPP AAA server in the mobile communication network, the 4G 3GPP AAA server detecting the concealed identifier sent in the first authentication message from the apparatus.

29. An apparatus comprising:
a processor; and
a memory coupled to the processor, the processor configured to cause the apparatus to:
receive a first authentication message from a network function to authenticate a remote unit with a mobile communication network via a non-3GPP access network, the first authentication message comprising an identifier for the remote unit and an authentication type;
detect that the identifier is a concealed identifier for the remote unit, the concealed identifier indicating that the remote unit is 5G capable;
create an authentication vector request message comprising the concealed identifier and an authentication method, the authentication type specifying the authentication method;
send the authentication vector request message to the network function, the network function de-concealing the concealed identifier to retrieve a permanent identifier for the remote unit; and
receive an authentication vector response message from the network function, the authentication vector response message comprising an authentication vector and the permanent identifier for the remote unit.

30. The apparatus of claim 29, wherein the processor is configured to cause the apparatus to detect the concealed identifier in a username portion of a network access identifier (“NAI”) that is received as part of the first authentication message instead of an international mobile subscriber identity (“IMSI”).

31. The apparatus of claim 30, wherein the concealed identifier comprises a subscription concealed identifier (“SUCI”) for the remote unit.

32. The apparatus of claim 29, wherein the network function that the authentication vector request message is sent to comprises a home subscriber server (“HSS”).

33. The apparatus of claim 29, wherein the network function that the authentication vector request message is sent to comprises a unified data management (“UDM”) server.

34. The apparatus of claim 33, wherein the processor is configured to cause the apparatus to select the UDM server based on routing information associated with the concealed identifier.

35. The apparatus of claim 33, wherein the apparatus is enhanced with a service based interface (“SBI”) to represent an authentication server function (“AUSF”) and communicate directly with the UDM server.

36. The apparatus of claim 35, wherein the authentication vector request message comprises one of:
a Nudm_UEAuthentication_Get request message in response to the apparatus hosting an SBI to communicate with the UDM; and
an authentication and key agreement (“AKA”) authentication vector (“AV”) request message in response to the apparatus hosting a AAA protocol interface with the UDM.

37. The apparatus of claim 29, wherein the network function that the authentication vector request message is sent to comprises an authentication server function (“AUSF”).

38. The apparatus of claim 37, wherein the authentication vector request message comprises one of:
a Nausf_UEAuthentication_Authenticate request message in response to the apparatus hosting a service based interface (“SBI”) with the AUSF, the apparatus acting as an access and mobility management function (“AMF”); and
an authentication and key agreement (“AKA”) authentication vector (“AV”) request message in response to the apparatus hosting a AAA protocol interface with the AUSF, the apparatus acting as a AAA proxy.

39. An apparatus comprising:
a processor; and
a memory coupled to the processor, the processor configured to cause the apparatus to:
receive an authentication vector request message from a network function to authenticate a remote unit with a mobile communication network via a non-3GPP access network, the authentication vector request message comprising an identifier for the remote unit and an authentication type;
detect that the identifier is a concealed identifier for the remote unit, the concealed identifier indicating that the remote unit is 5G capable;
de-conceal the concealed identifier to determine a permanent identifier for the remote unit;
create an authentication vector response message comprising the de-concealed permanent identifier for the remote unit and an authentication method, the authentication type specifying the authentication method; and
send the authentication vector response message to the network function.
